(19) United States
(12) Patent Application Publication
(10) Pub. No.: US 2025/0367545 A1
(43) Pub. Date: Dec. 4, 2025

(54) BUTTON ASSEMBLY AND CONTROLLER

(71) Applicant: VIVO MOBILE COMMUNICATION CO., LTD., Dongguan (CN)

(72) Inventor: Wanli HU, Dongguan (CN)

(73) Assignee: VIVO MOBILE COMMUNICATION CO., LTD., Dongguan (CN)

(21) Appl. No.: 19/305,744

(22) Filed: Aug. 20, 2025

Related U.S. Application Data
(63) Continuation of application No. PCT/CN2024/077338, filed on Feb. 18, 2024.

(30) Foreign Application Priority Data
Feb. 22, 2023 (CN) 202310150755.9

(51) Int. Cl. A63F 13/24

(52) U.S. Cl. CPC A63F 13/24

(57) ABSTRACT

A button assembly and a controller are provided. The button assembly includes a base, a pressing assembly, a first transmission component, a drive component, and a second transmission component. The pressing assembly is disposed on the base, and is configured to move relative to the base. A first end of the first transmission component is connected to the base. The drive component is connected to a second end of the first transmission component, and the drive component is configured to drive the first transmission component to rotate relative to the base in a second direction. The second transmission component is connected to the pressing assembly, and is connected to the first transmission component. The pressing assembly is configured to drive the second transmission component to move along the first transmission component, and to drive the first transmission component to rotate relative to the base in a first direction.

### CROSS-REFERENCE TO RELATED APPLICATIONS

This application is a continuation of International Application No. PCT/CN2024/077338, filed Feb. 18, 2024, which claims priority to Chinese Patent Application No. 202310150755.9, filed Feb. 22, 2023. The entire contents of each of the above-referenced applications are expressly incorporated herein by reference.

### TECHNICAL FIELD

This application relates to the field of controller technologies, and in particular, to a button assembly and a controller.

### BACKGROUND

In a related technology, a corresponding function button is disposed on a button assembly of a controller such as a game controller or an audio-visual controller, and a user controls the controller by operating the function button. However, when the user presses the corresponding function button, the function button can only trigger corresponding control. As a result, the button assembly has only a single function.

### SUMMARY

This application aims to provide a button assembly and a controller.

According to a first aspect, an embodiment of this application provides a button assembly. The button assembly includes a base, a pressing assembly, a first transmission component, a drive component, and a second transmission component. The pressing assembly is disposed on the base, and can move relative to the base. A first end of the first transmission component is connected to the base. The drive component is connected to a second end of the first transmission component, and the drive component can drive the first transmission component to rotate relative to the base in a second direction. The second transmission component is connected to the pressing assembly, and is connected to the first transmission component. The pressing assembly can drive the second transmission component to move along the first transmission component, and can drive the first transmission component to rotate relative to the base in a first direction, and the first direction and the second direction are a same direction or different directions.

According to a second aspect, an embodiment of this application provides a controller. The controller includes the button assembly in the foregoing technical solutions.

In this embodiment of this application, the button assembly includes a base and a pressing assembly, and the pressing assembly is disposed on the base, so that a user can implement an operation on the button assembly by touching the pressing assembly, and can further control the controller by using the button assembly. The button assembly further includes a first transmission component and a second transmission component. A first end of the first transmission component is connected to the base. The second transmission component is connected to the pressing assembly, and is connected to the first transmission component. The pressing assembly can drive the second transmission component to move along the first transmission component, and can drive the first transmission component to rotate relative to the base. In addition, the button assembly further includes a drive component. The drive component is connected to the first transmission component, and the drive component can also drive the first transmission component to rotate.

In this embodiment of this application, both the pressing assembly and the drive component can drive the first transmission component to rotate. Therefore, when the user touches the pressing assembly, the drive component is controlled to drive the first transmission component, and the drive component works with the pressing assembly, so that the user can obtain different tactile feedback when touching the pressing assembly, thereby enriching functions of the button assembly, enriching tactile sensory experience of the controller, and improving tactile sensory experience of the user.

Further, interaction experience between the user and an audio-visual entertainment device is improved. In addition, the button assembly implements tactile feedback by using the first transmission component, the drive component, and the second transmission component, so that a structure of the button assembly is simpler, a volume of the button assembly is reduced, and space occupied by the button assembly on the controller is reduced.

The controller includes the button assembly in the foregoing technical solutions. Therefore, the controller has all beneficial effect of the button assembly in any one of the foregoing technical solutions.

Additional aspects and advantages of this application are partially provided in the following descriptions, and will partially become apparent from the following descriptions, or may be learned from practice of this application.

### BRIEF DESCRIPTION OF DRAWINGS

The foregoing and/or additional aspects and advantages of this application will become apparent and readily understood from the descriptions of the embodiments with reference to the following accompanying drawings.

FIG. 1 is a first sectional view of a button assembly according to an embodiment of this application;

FIG. 2 is a second sectional view of a button assembly according to an embodiment of this application;

FIG. 3 is an exploded diagram of a button assembly according to an embodiment of this application;

FIG. 4 is a third sectional view of a button assembly according to an embodiment of this application;

FIG. 5 is a schematic diagram of a structure of a second transmission component of a button assembly according to an embodiment of this application;

FIG. 6 is a fourth sectional view of a button assembly according to an embodiment of this application;

FIG. 7 is a first schematic diagram of an overload protection structure according to an embodiment of this application; and

FIG. 8 is a second schematic diagram of an overload protection structure according to an embodiment of this application.

### REFERENCE NUMERALS

100: base; 110: first mounting hole; 120: sliding groove;
200: pressing assembly; 210: first pressing component; 220: swing arm; 222: first teeth; 230: second pressing component; 240: connecting rod; 250: first elastic member;
300: first transmission component; 310: first transmission rod; 320: first thread; 330: mounting portion; 340: positioning hole;
400: drive component; 410: output shaft;
500: second transmission component; 510: nut; 512: second teeth; 520: second thread; 530: protrusion;
610: rotating shaft; 620: baffle; 630: torsion spring;
700: shaft collar; 710: positioning groove;
810: second elastic member; 820: positioning pin; 830: magnetic member; 840: induction component.

### DETAILED DESCRIPTION

The following describes in more detail the example embodiments of this application with reference to the accompanying drawings. Although the example embodiments of this application are illustrated in the accompanying drawings, it should be understood that this application may be implemented in various forms without being limited to the embodiments described herein. On the contrary, these embodiments are provided to help more thoroughly understand this application and to fully convey the scope of this application to those skilled in the art.

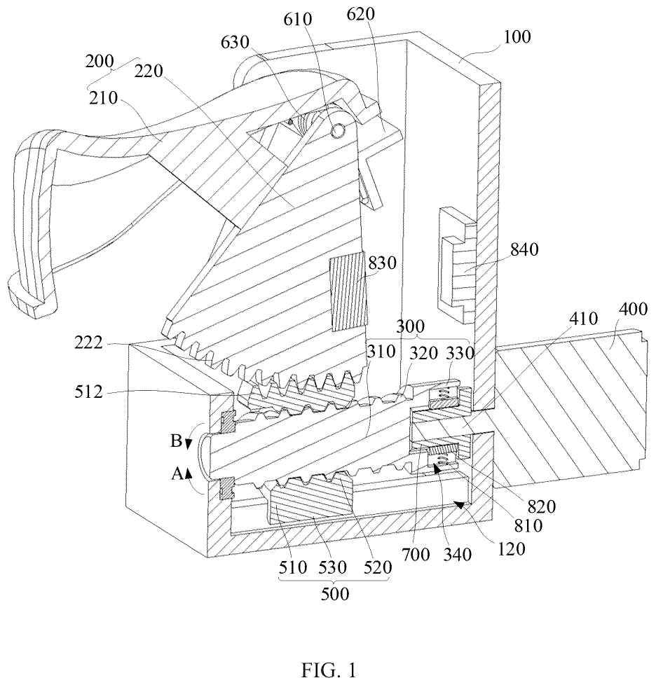

The following describes a button assembly and a controller according to the embodiments of this application with reference to FIG. 1 to FIG. 8.

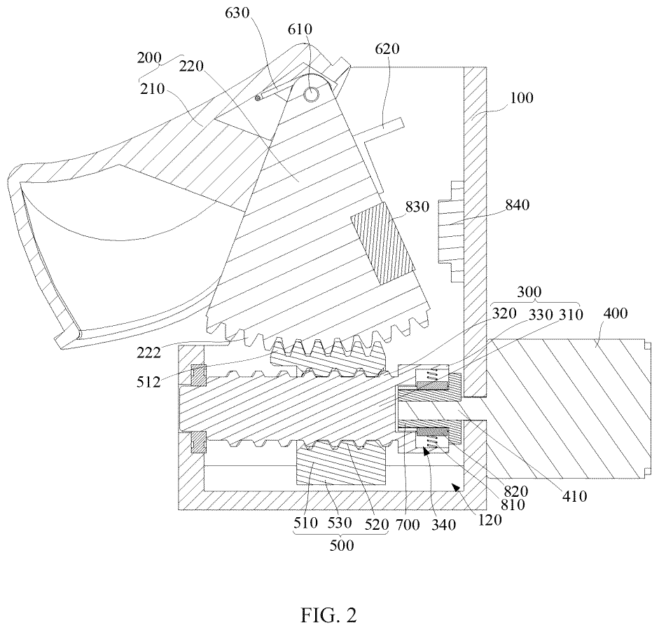

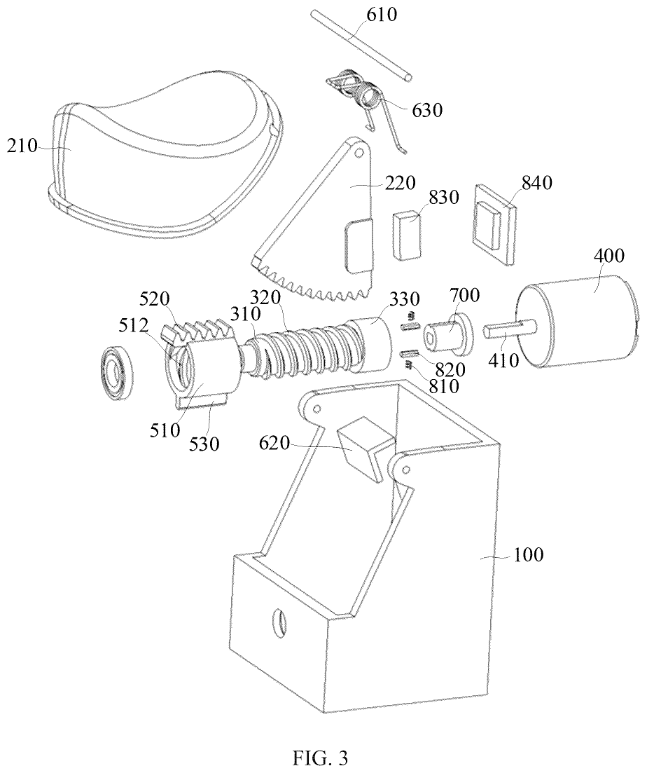

As shown in FIG. 1, FIG. 2, and FIG. 3, the button assembly disclosed in some embodiments of this application includes a base 100, a pressing assembly 200, a first transmission component 300, a drive component 400, and a second transmission component 500. The pressing assembly 200 is disposed on the base 100, and can move relative to the base 100. A first end of the first transmission component 300 is connected to the base 100. The drive component 400 is connected to a second end of the first transmission component 300, and the drive component 400 can drive the first transmission component 300 to rotate relative to the base 100 in a second direction. The second transmission component 500 is connected to the pressing assembly 200, and is connected to the first transmission component 300. The pressing assembly 200 can drive the second transmission component 500 to move along the first transmission component 300, and can drive the first transmission component 300 to rotate relative to the base 100 in a first direction, and the first direction and the second direction are a same direction or different directions.

The button assembly disclosed in the embodiments of this application includes the base 100 and the pressing assembly 200, and the pressing assembly 200 is disposed on the base 100, so that a user can implement an operation on the button assembly by touching the pressing assembly 200, and can further control the controller by using the button assembly.

The button assembly further includes the first transmission component 300 and the second transmission component 500. The first end of the first transmission component 300 is connected to the base 100. The second transmission component 500 is connected to the pressing assembly 200, and is connected to the first transmission component 300. The pressing assembly 200 can drive the second transmission component 500 to move along the first transmission component 300, and can drive the first transmission component 300 to rotate relative to the base 100.

In addition, the button assembly further includes the drive component 400. The drive component 400 is connected to the first transmission component 300, and the drive component 400 can also drive the first transmission component 300 to rotate. Both the pressing assembly 200 and the drive component 400 can drive the first transmission component 300 to rotate. Therefore, when the user touches the pressing assembly 200, the drive component 400 is controlled to drive the first transmission component, and the drive component 400 works with the pressing assembly 200, so that the user can obtain different tactile feedback when touching the pressing assembly 200, thereby enriching functions of the button assembly, enriching tactile sensory experience of the controller, and improving tactile sensory experience of the user. Further, interaction experience between the user and an audio-visual entertainment device is improved. In addition, the button assembly implements tactile feedback by using the first transmission component 300, the drive component 400, and the second transmission component 500, so that a structure of the button assembly is simpler, a volume of the button assembly is reduced, and space occupied by the button assembly on the controller is reduced.

In some embodiments, when the user touches the pressing assembly 200, the pressing assembly 200 drives the first transmission component 300 to rotate in the first direction by using the second transmission component 500. In this case, the drive component 400 is controlled to drive the first transmission component 300 to rotate in the second direction.

As shown in FIG. 1, both the first direction and the second direction are directions shown by an arrow A or an arrow B. When both the first direction and the second direction are a same direction, that is, both the pressing assembly 200 and the drive component 400 drive the first transmission component 300 to rotate in one direction, this is equivalent to that the drive component 400 provides a specific boost, making it easier for the user to touch the pressing assembly 200, so that the pressing assembly 200 can feed back force-relief tactile effect to the user.

As shown in FIG. 1, the first direction is a direction shown by the arrow A, and the second direction is a direction shown by the arrow B. When the first direction and the second direction are different directions, that is, the pressing assembly 200 and the drive component 400 drive the first transmission component 300 to rotate in different directions, this is equivalent to that the drive component 400 applies a resistance to the first transmission component 300, increasing a thrust required by the user to push the pressing assembly 200; and specific damping is applied to the pressing assembly 200 by using the drive component 400, so that the pressing assembly 200 can feed back counteractive tactile effect to the user.

When the second direction continuously changes, that is, when the drive component 400 drives the first transmission component 300 to switch between the two rotation directions, in particular, the second direction continuously changes at a short interval, the drive component 400 can apply a specific vibration to the pressing assembly 200 by using the first transmission component 300 and the second transmission component 500, so that the pressing assembly 200 can feed back tactile effect of one vibration to the user.

The drive component 400 may further apply rebound tactile feedback to the pressing assembly 200, so that the pressing assembly 200 can feed back rebound tactile effect to the user.

In some embodiments, the user touches the pressing assembly 200, and pushes the second transmission component 500 to translate along an axis of the first transmission component 300, and the second transmission component 500 drives the first transmission component 300 to rotate around the axis.

The drive component 400 drives the first transmission component 300 to rotate, and the first transmission component 300 can drive the second transmission component 500 to translate along the axis of the first transmission component 300, to drive the pressing assembly 200 to move.

In some embodiments, the drive component 400 is a motor, and the motor is fastened to the base 100. A fastening manner may be screw fastening, buckle fastening, bonding, or combination.

That is, the components of the interactive assembly can drive each other to move, and no self-locking phenomenon occurs.

According to some embodiments of this application, as shown in FIG. 1 and FIG. 2, the first transmission component 300 includes a first transmission rod 310 and a first thread 320, and the first thread 320 extends helically in a circumferential direction of the first transmission rod 310. The second transmission component 500 includes a nut 510, the nut 510 is sleeved on the first transmission rod 310, a second thread 520 is disposed on an inner ring of the nut 510, and the second thread 520 engages with the first thread 320.

In the embodiments, the first transmission component 300 includes the first transmission rod 310 and the first thread 320, and the first thread 320 extends helically from the first end of the first transmission rod 310 to the second end of the first transmission rod 310 in the circumferential direction of the first transmission rod 310. The second transmission component 500 includes the nut 510, the second thread 520 is disposed on the inner ring of the nut 510, and the second thread 520 extends helically from a first side of the nut 510 to a second side of the nut 510 in an axial direction along the inner ring of the nut 510. The nut 510 is sleeved on the first transmission rod 310, and the first thread 320 can engage with the second thread 520. When the nut 510 moves in an axial direction of the first transmission rod 310, the first transmission rod 310 can be driven to rotate, and the first transmission rod 310 rotating can drive the nut 510 to move in the axial direction of the first transmission rod 310, so that power can be bidirectionally transmitted; and when the drive component 400 drives the first transmission rod 310, the power can be transmitted to the pressing assembly 200, to implement tactile sensory feedback.

In some embodiments, the first transmission component 300 is a screw, the screw engages with the nut 510, and a lead angle of the screw is the same as that of the nut 510.

The lead angle of the screw and of the nut 510 is greater than an equivalent friction angle of mating surfaces of the screw and nut 510, to ensure that the screw and nut 510 can be bidirectionally driven without self-locking.

According to some embodiments of this application, as shown in FIG. 1 and FIG. 2, the pressing assembly 200 includes a first pressing component 210 and a swing arm 220. The first pressing component 210 is rotatably connected to the base 100. The swing arm 220 is rotatably connected to the base 100. The first pressing component 210 abuts against one side of the swing arm 220, and can drive the swing arm 220 to rotate relative to the base 100.

In the embodiments, the pressing assembly 200 includes the first pressing component 210, and the first pressing component 210 is rotatably connected to the base 100, so that the interactive assembly can be used as a controller with a rotating button, for example, an gun-shaped button assembly of a game device, and the first pressing component 210 can be used as a trigger button of the button assembly. The pressing assembly 200 further includes the swing arm 220, and the swing arm 220 is connected to the first pressing component 210, so that the first pressing component 210 can transmit power by using the swing arm 220, to work with the drive component 400, and implement tactile feedback.

Further, the swing arm 220 is of a sector shape, the first pressing component 210 abuts against the swing arm 220 on one side in a circumferential direction, and the user can push the swing arm 220 by pressing the first pressing component 210. The swing arm 220 can also push the first pressing component 210, to implement tactile feedback.

Further, the first pressing component 210 and the swing arm 220 may be of an integrated structure, or may be two separate components.

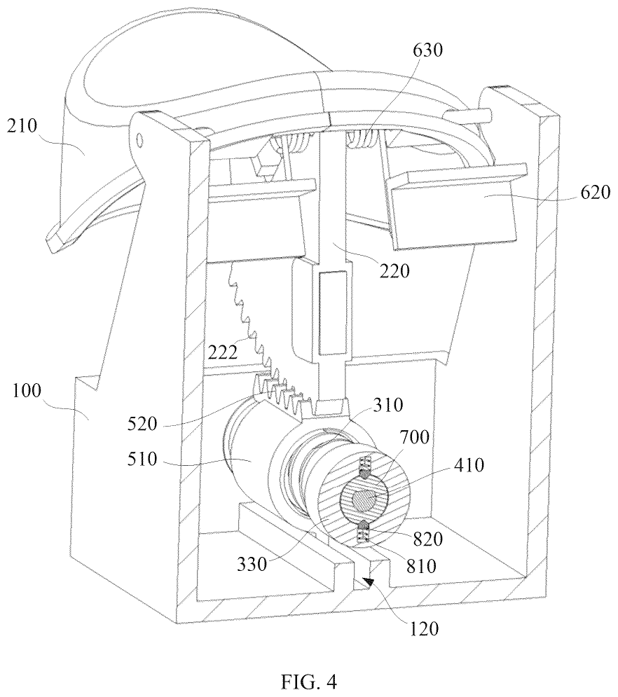

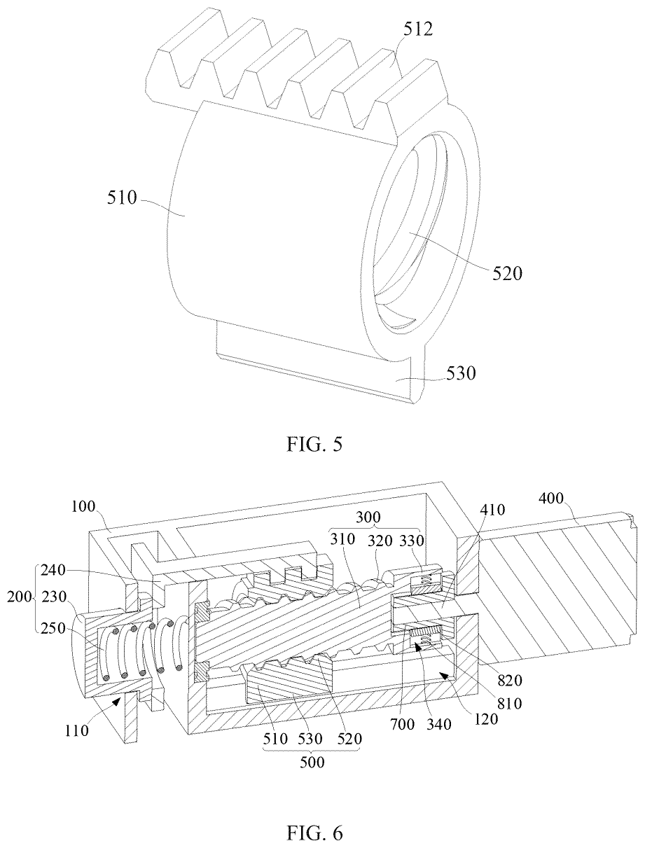

According to some embodiments of this application, as shown in FIG. 4 and FIG. 5, a plurality of first teeth 222 are disposed on one side, of the swing arm 220, that face the first transmission component 300, and the plurality of first teeth 222 are arranged along the axis of the first transmission component 300. A plurality of second teeth 512 are disposed on one side, of the nut 510, that are opposite to the swing arm 220, and the plurality of second teeth 512 mesh with the plurality of first teeth 222.

In the embodiments, the plurality of first teeth 222 are disposed on one side, of the swing arm 220, that face the first transmission component 300, the plurality of first teeth 222 are arranged along the axis of the first transmission component 300, the plurality of second teeth 512 are disposed on one side, of the nut 510, that are opposite to the swing arm 220, and the plurality of second teeth 512 mesh with the plurality of first teeth 222, to implement power transmission. When the swing arm 220 is pushed by the first pressing component 210, the first teeth 222 can push the second teeth 512, to push the nut 510 to move in the axial direction of the first transmission component 300. When the first transmission component 300 drives the nut 510 to move, the nut 510 can drive the swing arm 220 through meshing of the second teeth 512 and the first teeth 222, to implement tactile feedback.

Further, a rack is disposed on an outer peripheral wall of the nut 510, the second teeth 512 are disposed on the rack, and the plurality of second teeth 512 are arranged along the axis of the first transmission component 300.

According to some embodiments of this application, as shown in FIG. 1 and FIG. 2, the button assembly further includes a rotating shaft 610, and the rotating shaft 610 penetrates the first pressing component 210 and/or the swing arm 220, and is connected to the base 100.

In the embodiments, the button assembly further includes the rotating shaft 610, and the rotating shaft 610 penetrates the first pressing component 210 and/or the swing arm 220, and is connected to the base 100, so that the swing arm 220 and the first pressing component 210 can rotate relative to the base 100. In addition, the first pressing component 210 and/or the swing arm 220 are supported by using the same rotating shaft 610, to reduce a resistance between the first pressing component 210 and the swing arm 220 during rotation, thereby making the first pressing component 210 and the swing arm 220 rotate more flexibly, and improving tactile feedback effect.

Further, the rotating shaft 610 may penetrate the first pressing component 210. The first pressing component 210 can rotate relative to the base 100. The swing arm 220 is connected to the first pressing component 210. When the first pressing component 210 is pressed, the first pressing component 210 can drive the swing arm 220 to rotate together.

The rotating shaft 610 may also penetrate the swing arm 220. The swing arm 220 can rotate relative to the base 100. The swing arm 220 is connected to the first pressing component 210. When the first pressing component 210 is pressed, the first pressing component 210 can drive the swing arm 220 to rotate together.

The rotating shaft 610 may also penetrate the first pressing component 210 and the swing arm 220 at the same time, and the first pressing component 210 abuts against the swing arm 220. When the first pressing component 210 is pressed, the first pressing component 210 can drive the swing arm 220 to rotate together.

According to some embodiments of this application, as shown in FIG. 1 and FIG. 2, the button assembly further includes a baffle 620 and a torsion spring 630. The baffle 620 is connected to the base 100. The torsion spring 630 is sleeved on the rotating shaft 610, one side abuts against the first pressing component 210, and the other side abuts against the baffle 620.

In the embodiments, the button assembly further includes the baffle 620, and the baffle 620 is connected to the base 100. The button assembly further includes the torsion spring 630, the torsion spring 630 is sleeved on the rotating shaft 610, one side of the torsion spring 630 abuts against the first pressing component 210, and the other side of the torsion spring 630 abuts against the baffle 620, so that the torsion spring 630 can be compressed as the first pressing component 210 swings under force, and is restored to an initial position after the first pressing component 210 loses pressing force, thereby implementing resetting of the first pressing component 210.

In some embodiments, when the first pressing component 210 is at the initial position, the torsion spring 630 is in an original state of neither stretching nor compression, or is in a slightly compressed state. After the first pressing component 210 swings under force, a compression amount of the torsion spring 630 increases; and after the force of the first pressing component 210 disappears, the torsion spring 630 drives the first pressing component 210 to reset.

According to some embodiments of this application, as shown in FIG. 6, a first mounting hole 110 is provided on the base 100, and the pressing assembly 200 includes a second pressing component 230 and a connecting rod 240. A part of the second pressing component 230 is disposed in the first mounting hole 110, and can move relative to the base 100 along the axis of the first transmission component 300. A first end of the connecting rod 240 is connected to the second pressing component 230, and a second end of the connecting rod 240 is connected to the nut 510.

In the embodiments, the first mounting hole 110 is provided on the base 100, the pressing assembly 200 includes the second pressing component 230, and the second pressing component 230 is disposed in the first mounting hole 110, so that the second pressing component 230 can slide relative to the base 100. The pressing assembly 200 further includes the connecting rod 240, the first end of the connecting rod 240 is connected to the second pressing component 230, and the second end of the connecting rod 240 is connected to the nut 510, so that the second pressing component 230 may drive, by using the connecting rod 240, the nut 510 to move, and the drive component 400 drives the first transmission component 300 to perform tactile feedback on the user who touches the second pressing component 230.

In some embodiments, the second pressing component 230 may be a button of a controller such as a game button assembly or a mobile phone.

Further, a plurality of first bumps are provided at the second end of the connecting rod 240, the plurality of first bumps are arranged at an interval along the axis of the first transmission component 300, a plurality of second bumps are provided on one side, of the nut 510, that faces the connecting rod 240, the plurality of second bumps are arranged at an interval along the axis of the first transmission component 300, and the plurality of first bumps and the plurality of second bumps are alternately arranged.

According to some embodiments of this application, as shown in FIG. 6, the pressing assembly 200 further includes a first elastic member 250. A first end of the first elastic member 250 abuts against the second pressing component 230, and a second end abuts against the base 100.

In the embodiments, the pressing assembly 200 further includes the first elastic member 250, and two ends of the first elastic member 250 respectively abut against the second pressing component 230 and the base 100, so that the second pressing component 230 may be driven to reset by using the first elastic member 250.

In some embodiments, when the second pressing component 230 is not subject to force, the second pressing component 230 is at an initial position, and the first elastic member 250 is in an original state of neither compressing nor stretching, or the first elastic member 250 is in a slightly compressed state. After the second pressing component 230 moves under force, the first elastic member 250 is compressed. After the force of the second pressing component 230 disappears, the first elastic member 250 drives the second pressing component 230 to reset.

Further, the first elastic member 250 may be a spring, may be an elastic foam, or may be another plastic member with elasticity.

According to some embodiments of this application, as shown in FIG. 1 and FIG. 2, a sliding groove 120 is provided on the base 100, and the sliding groove 120 extends along the axis of the first transmission component 300. A protrusion 530 is provided on one side, of the nut 510, that is opposite to the sliding groove 120, and the protrusion 530 is embedded in the sliding groove 120.

In the embodiments, the sliding groove 120 is provided on the base 100, the protrusion 530 is provided on one side, of the nut 510, that is opposite to the sliding groove 120, and the protrusion 530 is embedded in the sliding groove 120. Because the sliding groove 120 extends along the axis of the first transmission component 300, the protrusion 530 can slide in the sliding groove 120, so that movement of the nut 510 can be guided by using the sliding groove 120, and rotation of the nut 510 can be avoided, thereby ensuring stability in a tactile feedback process.

In some embodiments, two stoppers are provided on a bottom wall of the base 100, the two stoppers extend along the axis of the first transmission component 300, and the sliding groove 120 is formed between the two stoppers.

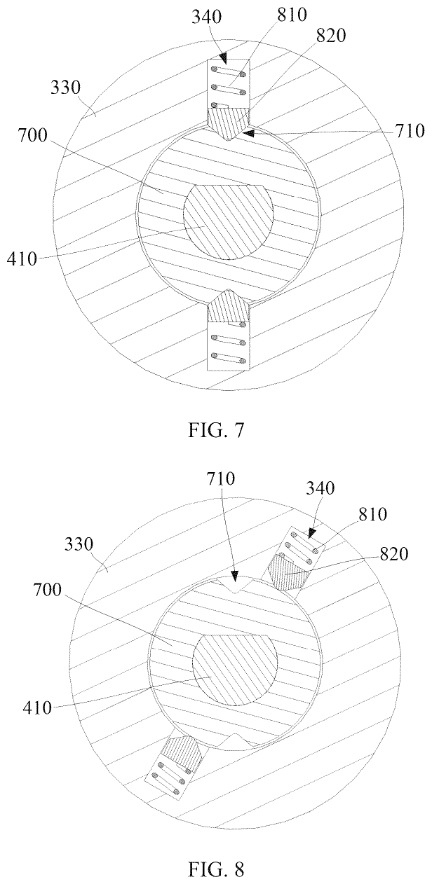

According to some embodiments of this application, as shown in FIG. 7 and FIG. 8, the first transmission component 300 further includes a mounting portion 330, disposed at one end of the first transmission rod 310. The button assembly further includes a shaft collar 700, and the shaft collar 700 is sleeved on an output shaft 410 of the drive component 400, and is embedded in the mounting portion 330.

In the embodiments, the first transmission component 300 further includes the mounting portion 330, the mounting portion 330 is of a ring shape and is connected to one end, of the first transmission rod 310, that faces the drive component 400, the button assembly further includes the shaft collar 700, and the shaft collar 700 is sleeved on the output shaft 410 of the drive component 400, and is embedded in the mounting portion 330, to implement the connection between the first transmission rod 310 and the drive component 400, so that the drive component 400 can drive the first transmission rod more stably.

In addition, the first transmission rod 310 is connected to the drive component 400 by using the mounting portion 330 and the shaft collar 700, so that a structure of the connection between the drive component 400 and the first transmission rod 310 is simpler, and assembly is more convenient.

According to some embodiments of this application, as shown in FIG. 7 and FIG. 8, a positioning hole 340 extending in a radial direction is provided on the mounting portion 330, a positioning groove 710 extending in the radial direction is provided on the shaft collar 700, and the positioning hole 340 is opposite to the positioning groove 710. The button assembly further includes a second elastic member 810 and a positioning pin 820. The second elastic member 810 is disposed in the positioning hole 340. The positioning pin 820 is embedded in the positioning hole 340, abuts against the second elastic member 810, and can snap into the positioning groove 710.

In the embodiments, the button assembly further includes the positioning pin 820, and the positioning pin 820 is embedded in the positioning hole 340 that extends in the radial direction and provided on the mounting portion 330 and the positioning groove 710 that extends in the radial direction and provided on the shaft collar 700, to implement transmission of power between the shaft collar 700 and the mounting portion 330, so that the drive component 400 can transmit the power to the first transmission rod 310 by using the shaft collar 700 and the mounting portion 330. The button assembly further includes the second elastic member 810, the second elastic member 810 is disposed in the positioning hole 340, and two ends of the second elastic member 810 respectively abut against the positioning pin 820 and the mounting portion 330. When an interaction torque between the mounting portion 330 and the shaft collar 700 is large, the positioning pin 820 can be separated from the positioning groove 710, and the entire positioning pin 820 enters the positioning hole 340, so that the mounting portion 330 and the shaft collar 700 are separated, thereby avoiding damage to the drive component 400 due to overload, and implementing overload protection on the drive component 400.

In some embodiments, an overload protection structure includes the second elastic member 810 and the positioning pin 820.

In some embodiments, the positioning groove 710 is a concave surface recessed towards an axis of the shaft collar 700, one end, of the positioning pin 820, that faces the positioning groove 710 is a convex surface, and the convex surface fits into the groove.

As shown in FIG. 7, in a normal state, the positioning pin 820 is affected by elastic force of the second elastic member 810, and a convex surface of the positioning pin 820 is pressed against a concave notch of the shaft collar 700. When a motor shaft and the shaft collar 700 rotate, a torque does not exceed a threshold, and the shaft collar 700 and the positioning pin 820 are closely connected to each other by the elastic force of the second elastic member 810. The positioning pin 820 rotates together with the shaft collar 700, and a side wall of the positioning pin 820 acts on the positioning hole 340 inside the mounting portion 330, to further drive the first transmission rod 310 to rotate. In this state, the positioning pin 820 is connected to the shaft collar 700 and the first transmission rod 310 as middleware.

As shown in FIG. 8, when the load torque exceeds the threshold, the elastic force acting on the convex surface of the positioning pin 820 is greater than the elastic force of the first elastic member 250. The convex surface of the positioning pin 820 is pushed back to the positioning hole 340 of the mounting portion 330, the concave notch of the shaft collar 700 disengages from the positioning pin 820, and transmission of the motor and the first transmission rod 310 is disconnected, thereby preventing a large torque from damaging the motor, and protecting the motor.

An axial cross-section of the positioning groove 710 is U-shaped, V-shaped, and circular arc-shaped, and may also be a groove with an inclined inner wall in another shape. One end, of the positioning pin 820, that faces the positioning groove 710 and is adapted to the positioning groove 710.

In some embodiments, the second elastic member 810 is an elastic element such as a spring or an elastic foam.

According to some embodiments of this application, as shown in FIG. 1 and FIG. 2, the button assembly further includes a magnetic member 830 and an induction component 840. The magnetic member 830 is disposed on the pressing assembly 200. The induction component 840 is disposed on the base 100, is opposite to the magnetic member 830, and can detect a position of the pressing assembly 200 based on a magnetic field change of the magnetic member 830.

In the embodiments, the button assembly further includes the magnetic member 830 and the induction component 840. The magnetic member 830 is disposed on the pressing assembly 200, the induction component 840 is disposed on the base 100, the magnetic member 830 can generate a magnetic field, and the induction component 840 can detect the magnetic field change. When the pressing assembly 200 moves under force, the magnetic member 830 moves with the pressing assembly 200, and the magnetic field generated by the magnetic member 830 changes, so that the induction component 840 can detect the position of the pressing assembly 200 based on the magnetic field change, and further control the drive component 400 to move based on the position of the pressing assembly 200.

In an embodiment of this application, a controller is provided. The controller includes the foregoing button assembly. The controller may be a VR (Virtual Reality) controller, an AR (Augmented Reality) controller, an MR (Mixed Reality) controller, or an XR (Extended Reality) controller. The controller may be connected to an electronic device, and the electronic device includes an AR device/VR device/MR device. The user operates a VR/AR application on the electronic device based on the controller. The user may implement interaction with the electronic device by operating the controller, and control display content of the AR device/VR device/MR device.

It should be noted that in this specification, relational terms such as first and second are only used to distinguish one entity or operation from another, and do not necessarily require or imply that any actual relationship or sequence exists between these entities or operations. In addition, the terms “include”, “comprise”, or any other variant thereof is intended to cover a non-exclusive inclusion, so that a process, a method, an article, or a device that includes a list of elements not only includes those elements but also includes other elements that are not expressly listed, or further includes elements inherent to such a process, method, article, or device. In the absence of more constraints, an element defined by “including a/an . . . ” does not exclude presence of other identical elements in the process, method, article, or device that includes the element.

The embodiments of this specification are described in a related manner. For the same or similar parts in the embodiments, refer to each other. Each embodiment focuses on a difference from other embodiments. Embodiments of an apparatus, an electronic device, a computer-readable storage medium, and a computer program product including an instruction are described simply because the embodiments are basically similar to the method embodiment. For related parts, refer to partial descriptions in the method embodiment.

The foregoing descriptions are merely embodiments of this application, and are not intended to limit the protection scope of this application. Any modification, equivalent replacement, improvement, or the like made without departing from the principle of this application shall fall within the protection scope of this application.

1. A button assembly, comprising:
a base;
a pressing assembly, wherein the pressing assembly is disposed on the base, and is configured to move relative to the base;
a first transmission component, wherein a first end of the first transmission component is connected to the base;
a drive component, wherein the drive component is connected to a second end of the first transmission component, and the drive component is configured to drive the first transmission component to rotate relative to the base in a second direction; and
a second transmission component, wherein the second transmission component is connected to the pressing assembly, and is connected to the first transmission component, wherein
the pressing assembly is configured to drive the second transmission component to move along the first transmission component, and to drive the first transmission component to rotate relative to the base in a first direction, and the first direction and the second direction are a same direction or different directions.

2. The button assembly according to claim 1, wherein the first transmission component comprises a first transmission rod and a first thread, and the first thread extends helically in a circumferential direction of the first transmission rod; and
the second transmission component comprises a nut, the nut is sleeved on the first transmission rod, a second thread is disposed on an inner ring of the nut, and the second thread engages with the first thread.

3. The button assembly according to claim 2, wherein the pressing assembly comprises:
a first pressing component, wherein the first pressing component is rotatably connected to the base; and
a swing arm, wherein the swing arm is rotatably connected to the base,
wherein the first pressing component abuts against one side of the swing arm, and is configured to drive the swing arm to rotate relative to the base.

4. The button assembly according to claim 3, wherein a plurality of first teeth are disposed on one side of the swing arm that faces the first transmission component, and the plurality of first teeth are arranged along an axis of the first transmission component; and
a plurality of second teeth disposed on one side of the nut that are opposite to the swing arm, and the plurality of second teeth mesh with the plurality of first teeth.

5. The button assembly according to claim 3, further comprising:
a rotating shaft, wherein the rotating shaft penetrates the first pressing component or the swing arm, and is connected to the base.

6. The button assembly according to claim 5, further comprising:
a baffle, wherein the baffle is connected to the base; and
a torsion spring, wherein the torsion spring is sleeved on the rotating shaft, one side abuts against the first pressing component, and the other side abuts against the baffle.

7. The button assembly according to claim 2, wherein a first mounting hole is provided on the base, and the pressing assembly comprises:
a second pressing component, wherein a part of the second pressing component is disposed in the first mounting hole, and is configured to move relative to the base along an axis of the first transmission component; and
a connecting rod, wherein a first end of the connecting rod is connected to the second pressing component, and a second end of the connecting rod is connected to the nut.

8. The button assembly according to claim 7, wherein the pressing assembly further comprises:
a first elastic member, wherein a first end of the first elastic member abuts against the second pressing component, and a second end abuts against the base.

9. The button assembly according to claim 2, wherein a sliding groove is provided on the base, and the sliding groove extends along the axis of the first transmission component; and
a protrusion is provided on one side of the nut that is opposite to the sliding groove, and the protrusion is embedded in the sliding groove.

10. The button assembly according to claim 2, wherein the first transmission component further comprises a mounting portion disposed at one end of the first transmission rod, and the button assembly further comprises:
a shaft collar, wherein the shaft collar is sleeved on an output shaft of the drive component, and is embedded in the mounting portion.

11. The button assembly according to claim 10, wherein a positioning hole extending in a radial direction is provided on the mounting portion, a positioning groove extending in the radial direction is provided on the shaft collar, and the positioning hole is opposite to the positioning groove, and the button assembly further comprises:
a second elastic member, wherein the second elastic member is disposed in the positioning hole; and
a positioning pin, wherein the positioning pin is embedded in the positioning hole, abuts against the second elastic member, and is configured to snap into the positioning groove.

12. The button assembly according to claim 1, further comprising:
a magnetic member, wherein the magnetic member is disposed on the pressing assembly; and
an induction component, wherein the induction component is disposed on the base, is opposite to the magnetic member, and is configured to detect a position of the pressing assembly based on a magnetic field change of the magnetic member.

13. A controller, comprising: a button assembly, wherein the button assembly comprises:
a base;
a pressing assembly, wherein the pressing assembly is disposed on the base, and is configured to move relative to the base;
a first transmission component, wherein a first end of the first transmission component is connected to the base;
a drive component, wherein the drive component is connected to a second end of the first transmission component, and the drive component is configured to drive the first transmission component to rotate relative to the base in a second direction; and
a second transmission component, wherein the second transmission component is connected to the pressing assembly, and is connected to the first transmission component, wherein
the pressing assembly is configured to drive the second transmission component to move along the first transmission component, and to drive the first transmission component to rotate relative to the base in a first direction, and the first direction and the second direction are a same direction or different directions.

14. The controller according to claim 13, wherein the first transmission component comprises a first transmission rod and a first thread, and the first thread extends helically in a circumferential direction of the first transmission rod; and
the second transmission component comprises a nut, the nut is sleeved on the first transmission rod, a second thread is disposed on an inner ring of the nut, and the second thread engages with the first thread.

15. The controller according to claim 14, wherein the pressing assembly comprises:
a first pressing component, wherein the first pressing component is rotatably connected to the base; and
a swing arm, wherein the swing arm is rotatably connected to the base,
wherein the first pressing component abuts against one side of the swing arm, and is configured to drive the swing arm to rotate relative to the base.

16. The controller according to claim 15, wherein a plurality of first teeth are disposed on one side of the swing arm that faces the first transmission component, and the plurality of first teeth are arranged along an axis of the first transmission component; and
a plurality of second teeth disposed on one side of the nut that are opposite to the swing arm, and the plurality of second teeth mesh with the plurality of first teeth.

17. The controller according to claim 15, further comprising:
a rotating shaft, wherein the rotating shaft penetrates the first pressing component or the swing arm, and is connected to the base.

18. The controller according to claim 17, further comprising:
a baffle, wherein the baffle is connected to the base; and
a torsion spring, wherein the torsion spring is sleeved on the rotating shaft, one side abuts against the first pressing component, and the other side abuts against the baffle.

19. The controller according to claim 14, wherein a first mounting hole is provided on the base, and the pressing assembly comprises:
a second pressing component, wherein a part of the second pressing component is disposed in the first mounting hole, and is configured to move relative to the base along an axis of the first transmission component; and
a connecting rod, wherein a first end of the connecting rod is connected to the second pressing component, and a second end of the connecting rod is connected to the nut.

20. The controller according to claim 19, wherein the pressing assembly further comprises:
a first elastic member, wherein a first end of the first elastic member abuts against the second pressing component, and a second end abuts against the base.
